(19) United States
(12) Patent Application Publication
(10) Pub. No.: US 2024/0361749 A1
(43) Pub. Date: Oct. 31, 2024

(54) LOW-LATENCY, RESILIENT PUBLISH/SUBSCRIBE FLUID-HANDLING SYSTEM

(71) Applicant: SitePro, Inc., Lubbock, TX (US)

(72) Inventors: Aaron Phillips, Lubbock, TX (US); David Bateman, Lubbock, TX (US); Josh Cobb, Lubbock, TX (US)

(21) Appl. No.: 18/600,426

(22) Filed: Mar. 8, 2024

Related U.S. Application Data
(60) Provisional application No. 63/489,310, filed on Mar. 9, 2023.

(51) Int. Cl. G05B 19/4099

(52) U.S. Cl. CPC G05B 19/4099; G05B 2219/37371

(57) ABSTRACT

A message-oriented method that includes receiving a first message that includes first sensor data obtained by a first sensor, wherein the first message is associated with a first publishing identifier such that the first sensor is configured to obtain the first sensor data. The method further includes one or more computer systems that are subscribed to the first publishing identifier and providing the first message that includes the first sensor data to a first computer system of the one or more computer systems and the first computer system is disposed at a first fluid handling site, the first computer system being configured to provide control of at least one fluid handling component.

### CROSS-REFERENCE TO RELATED APPLICATIONS

The present patent application claims the benefit of U.S. Provisional Pat. App. 63/489,310, titled LOW-LATENCY, RESILIENT PUBLISH/SUBSCRIBE FLUID-HANDLING SYSTEM filed 9 Mar. 2023. The entire content of each afore-mentioned patent filing is hereby incorporated by reference.

### BACKGROUND

### 1. Field

The present invention relates generally to publish/subscribe communications and, more specifically, to publish/subscribe communications for fluid-handling devices.

### 2. Description of the Related Art

Fluid-handling devices, such as valves, pumps, and various other forms of process equipment, in many use cases, are widely geographically distributed. For example, when such devices are used to extract petroleum products from an oil well, the associated fluid source or receptacle may be in a relatively remote location, as oil wells are generally distributed relative to one another and located remote from metropolitan areas. Similar issues arise in relation to petro-water disposal facilities, re-injection facilities, and petroleum pumping stations, all of which tend to be geographically distributed and include fluid-handling equipment.

### SUMMARY

The following is a non-exhaustive listing of some aspects of the present techniques. These and other aspects are described in the following disclosure.

Some aspects include a process including: receiving, by a messaging server, a first message that includes first sensor data obtained by a first sensor, wherein the first message is associated with a first publishing identifier, wherein the first sensor is configured to obtain the first sensor data; determining, by the messaging server, one or more computer systems that are subscribed to the first publishing identifier; and providing, by the messaging server, the first message that includes the first sensor data to a first computer system of the one or more computer systems, wherein the first computer system is disposed at a first fluid handling site, the first computer system being configured to provide control of at least one fluid handling component.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates an example of a command-center server, a site master-controller, and a messaging server in accordance with some embodiments of the present disclosure;

FIG. 2 illustrates a schematic view of a messaging server, in accordance with some embodiments of the present disclosure;

FIG. 3 illustrates an example of a process by which remote control of fluid-handling devices is exercised in accordance with some embodiments of the present disclosure;

FIG. 4 illustrates an example of a process by which low-latency, resilient messaging of fluid-handling devices is exercised in accordance with some embodiments of the present disclosure;

FIG. 5 illustrates an example of a computing device by which some of the hardware and the processes of FIG. 1-4 may be implemented in accordance with some embodiments of the present disclosure.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the applicants had to both invent solutions and, in some cases just as importantly, recognize problems overlooked (or not yet foreseen) by others in the field of information communications related to fluid-handling devices. Indeed, applicants wish to emphasize the difficulty of recognizing those problems that are nascent and will become much more apparent in the future should trends in industry continue as applicants expect. Further, because multiple problems are addressed, it should be understood that some embodiments are problem-specific, and not all embodiments address every problem with traditional systems described herein or provide every benefit described herein. That said, improvements that solve various permutations of these problems are described below. Indeed, some embodiments include both mechanical and data-processing improvements that may be integrated or used separately.

When monitoring or controlling such fluid-handling devices, it can be time-consuming and expensive for a technician to manually adjust or otherwise control them, as the technician will incur costs and delays by traveling to the device to make adjustments or gather data in person. These adjustments and inspections often occur relatively frequently, as process conditions and market demand fluctuate, thereby further increasing costs.

Some systems exist for exercising remote monitoring of fluid-handling devices, such as various supervisory control and data acquisition (SCADA) systems, but many of these systems fail when a network connection is lost. Remote logic controlling such systems generally ceases to exercise control when the remote logic is disconnected in the event of a network failure. Further, some SCADA systems require the installation of special-purpose software on a computing device in order to exercise control remotely, which tends to deter users from exercising remote control of fluid-handling devices due to the burden of configuring each computer from which remote control is exercised.

Furthermore, while fluid-handling devices may be remote, they may be part of a larger system of fluid-handling. Furthermore, fluid-handling device may be in the vicinity of other fluid-handling devices that are independent of each other but may benefit from certain sensor data based on the geolocation. For example, a temperature sensor, a pressure sensor, an anemometer at one fluid-handling device may include valuable information for another fluid-handling device that is within a mile, five miles, ten miles or other range of distance from that sensor when handling fluids. However, existing systems do not provide for a low latency (e.g., less than 50 msec) and resiliency.

Traditional fluid-handling networking architectures may be built around a master/slave or client/server concept. In these scenarios, programmable logic controllers (PLCs) or host workstations practice one-to-one or one-to-many communications with field instruments, like sensors and valves, to collect the information they need for a particular application or execute a specific control algorithm. A master PLC, or specified client, sends a direct request for information, like temperature readings or cycle times, and the appropriately designated slave devices or servers respond accordingly at agreed-upon intervals.

While this tightly coupled communication paradigm works when there are limited data sharing requirements, increased network throughput and data formatting arise when scaling of distributed sensors, devices, and fluid-handling equipment is enlisted to share data in real-time to support automation applications. As such, systems and method of the present disclosure implement the publish/subscribe model, which decouples all devices from one another as well as applications from endpoint devices. In some publish/subscribe architectures, a central broker may receive and distribute all data. Clients may subscribe to the data they require, and the message broker automatically routes the appropriate data to all requesting subscribers, eliminating the burden of constantly polling devices for message updates. Also, in the publish/subscribe model, data may only be communicated when it changes-static data is not repeatedly sent. This approach significantly reduces network traffic and allows the system to be more scalable. Network architecture is also streamlined because, instead of one device needing to communicate with dozens of devices or applications to perform a particular function, communication is established via a single server that relays information to any device or application that wants it. Publish/subscribe also mitigates having to engineer custom code and complex mapping to share data between proprietary devices and over different networking protocols.

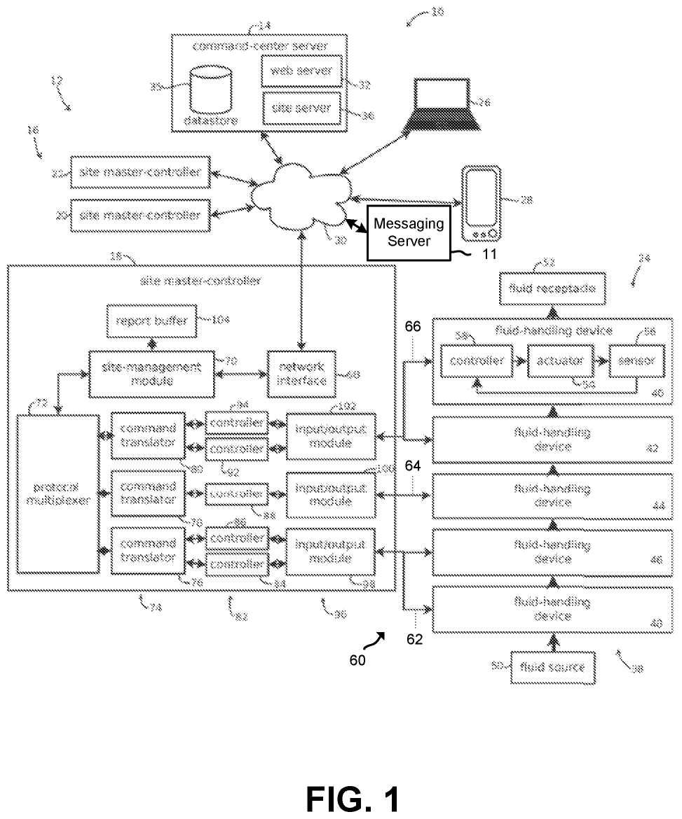

FIG. 1 illustrates a computing environment 10 having a control system 12 that, in some implementations, addresses deficiencies in certain SCADA systems for exercising remote control of fluid-handling devices as well as provides a low-latency, resilient messaging service that addresses some of the deficiencies in conventional fluid-handling Internet of Things (IoT) systems. These aspects are described in greater detail below, beginning with the remote-control aspects and concluding with the low-latency, resilient messaging service. Together, these features facilitate relatively low-cost, highly informed remote control and automation of fluid handling sites though a software-as-service solution that shields end users from much of the complexity of the present system. (It should be noted, though, that not all embodiments necessarily provide these benefits, as the different features are also independently useful.)

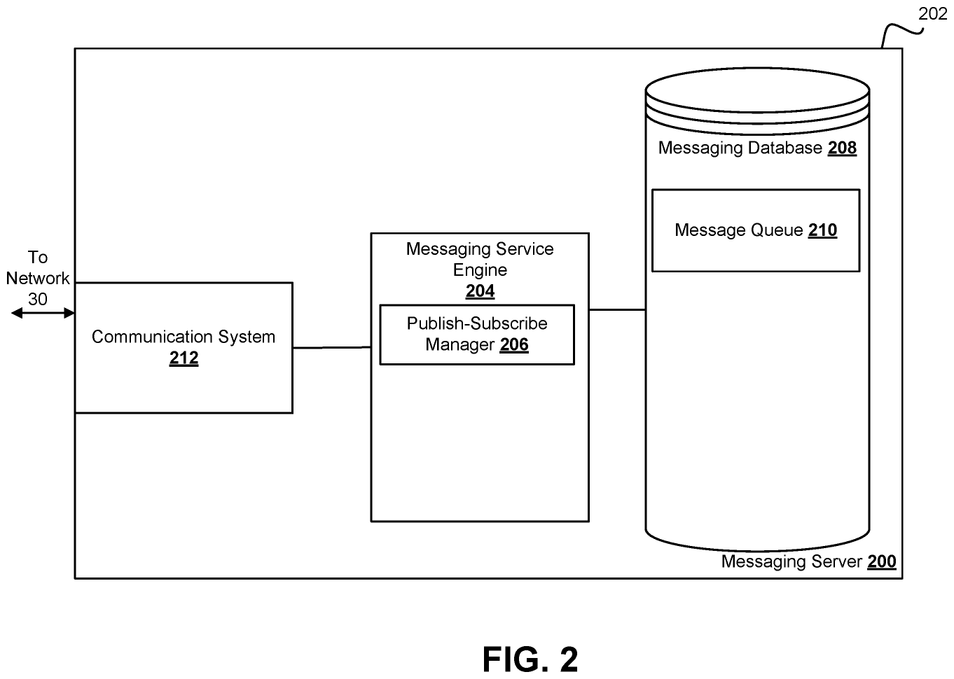

As explained in greater detail below, the control system 12 of this embodiment includes a messaging server 11 (described below with reference to FIG. 2), a command-center server 14 and site master-controllers 16 (specifically, in this example, three such site master-controllers 18, 20, and 22) that cooperate to facilitate remote control at a fluid-handling site 24 from user devices 26 or 28 via the Internet 30. Each site master-controller 16 may be co-located with a corresponding fluid-handling site 24 and, in some embodiments, may include logic that implements remotely issued commands, such that once a command is issued from user devices 26 or 28 and received at a site master-controller 16, the site master-controller 16, in some embodiments, executes the command to completion, even if Internet access is lost before the command is fully executed. Further, the site master-controller 16 of some embodiments may be operative to translate commands into various device-specific protocols, such that a single implementation of the site master-controller 16 is relatively versatile regardless of the type of fluid-handling device being controlled. In some implementations, the command-center server 14 may be operative to present a command interface and receive commands via a web interface in a web browser on user devices 26 and 28, such that fluid-handling devices can be controlled remotely without the need to install special-purpose software on the computing device through which remote control is exercised. It should be noted, however, that not all embodiments provide all these benefits, as various engineering and cost trade-offs are envisioned, and some embodiments may provide other or none of these benefits.

In some embodiments, the command-center server 14 includes a web server 32, a data store 34, and a site server 36. The command-center server 14 may act as a central node through which any of a plurality of user devices, such as user devices 26 and 28 (e.g., laptops, tablets, desktop computers, smartphones, and the like), issue commands to any of a plurality site master-controller 16, provided that such access is authorized. Only two user devices and three site master-controllers are shown for simplicity of explanation, but implementations including substantially more of each are envisioned, such as more than several hundred or several thousand user devices and more than several hundred or several thousand site master-controllers, for example. That said, embodiments are also consistent with a single user device and a single site master-controller.

The illustrated web server 32 may be operative to send instructions to present a control interface on the user devices 26 and 28, for example in a web browser on an operating system executed by processors and stored by memory of the user devices 26 or 28. The web server 32 may be operative to receive a request for such an interface from one of the user devices 26 or 28, send instructions (for example HTML JavaScript, and cascading stylesheets) to the user devices 26 that when rendered in a browser of the user devices 26 or 28, presents the control interface. The control interface may include buttons, text-input fields, and the like, that when interacted with by a user (e.g., touching, clicking, keying in text, and the like) generated events handled by the control interface and which cause corresponding commands to be sent from the user devices 26 or 28 to the command-center server 14. Other embodiments may have a special-purpose application executing on the user devices 26 and 28 for presenting the control interface and sending commands to the command-center server 14, e.g., a smartphone app that communicates via a web-based application program interface. The command-center server 14 may interact with the user devices 26 and 28 via an Internet Protocol (IP) address of the command-center server 14 and a port, such as port 80, which may be different from a port by which the command-center server 14 communicates with the various site master-controller 16, as described below, to keep traffic from the different components separate.

The web server 32 may also be operative to send instructions to present reports, and interfaces by which such reports are selected, to the user devices 26 or 28 responsive to user requests for such information or interfaces. As explained in greater detail below, the site master-controller 16 may report various process data, and the web server 32 may present this process data to users upon request. This process data may be stored in the data store 34.

In the data store 34 of some embodiments, the site master-controllers 16 may be organized according to user accounts, with each site master-controller 16 corresponding to at least one user account and some user accounts corresponding to multiple site master-controllers 16, as some users may have, for example, a plurality of oil wells or other facilities which the user wishes to control or monitor. In some embodiments, the data store 34 includes a plurality of account records, each account record having one or more user names, one or more user passwords, billing information (e.g., billing address, subscription price, and invoicing data), and identifiers of one or more site master-controllers (e.g. an IP address of each site master-controller) with which users under the corresponding account are authorized to interact (e.g., issue commands or view reports of data from the site master-controller). The data store 34 may encode such arrangements of data in a variety of formats, including a relational database, program state, hierarchical key-value pairs, a flat file, or other information encoded in a tangible, non-transitory, machine-readable medium, such as a hard drive or random access memory.

The illustrated site server 36 may be operative to interface between the command-center server 14 and the site master-controllers 16 by directing commands received via the web server 32 to the site master-controller 16 to which the command is addressed and receiving process data from the respective site master-controllers to be stored in the data store 34 or presented to the users via the web server 32. In some embodiments, the site server 36 is operative to receive a command via the web server 32, identify an IP address of the site master-controller 16 to which the command is addressed, and send the command to the respective site master-controller 16, for example via an IP address of the command set center server (which may be the same as that of the web server 32 or different) and via a port of the command-center server 14 (which may be different from a port used for the web server 32, or some embodiments may use the same port).

The data store 34, web server 32, and site server 36 may be co-located, for example in a single computing device, or these components 32 and 34 may be distributed across a number of computing devices, either co-located or physically distributed. The web server 32 and site server 36 may be operative to issue queries to the data store 34 to implement requests from the user devices 26 or 28, and the web server 32 may communicate with the site server 36 to effectuate commands.

In some embodiments, each site master-controller 16 controls a respective fluid-handling site 24 (only one of which is shown for site master-controller 18, though each of the other site master-controllers 20 and 22 may be associated with their own, differently located fluid-handling site, or some sites may have multiple site master controllers). The site master-controller 16 may receive commands from the command-center server 14 and implement those commands to completion, for example without further feedback to, and control signals from, the command-center server 14, such that the command can be executed even if a network connection to the command-center server 14 is temporarily lost. Further, the site master-controller 16 may be operative to report process data to the command-center server 14 for storage in the data store 34 and presentation via the web server 32 on user devices 26 and 28. In various embodiments, the site master-controller 16 may be operative to publish process data to the messaging server 11.

In some embodiments, the site master-controllers 16 are physically located at an associated fluid-handling site 24. For example, the site master-controller 18 may be connected to the fluid-handling site via a private network through which communications are sent without passing through the public Internet, and in some cases, the site master-controller 18 may be within a mile of the fluid-handling site 24, to give one example of co-location. The site master-controllers 16 may be geographically remote from one another, the command-center server 14, and the user devices 26 and 28 (each of which may also be remote from one another). For example, each of these components may be more than 1 mile from one another or not connected to one another via a private network. In some cases, though, some sites may have multiple site master-controllers co-located at a single site or some user devices may be co-located.

To execute commands at the fluid-handling site 24, the site master-controller 18 translates the received commands into a protocol appropriate for a corresponding fluid-handling device 38 (identified individually by reference numbers 40, 42, 44, 46, and 48). Accordingly, the features of the fluid-handling site 24 are described before addressing internal components of the exemplary site master-controller 18 to explain the environment in which the site master-controller 18 operates.

In this embodiment, the fluid-handling site 24 includes a plurality of fluid-handling devices 38 that are fluidly coupled to a fluid source 50 or a fluid receptacle 52, such that fluids (e.g., liquids or gases) can flow to, from, or through the respective fluid-handling device 38. The illustrated embodiment includes five fluid-handling devices, but other embodiments may include different numbers of such devices coupled to the various site master-controllers 16.

The fluid-handling devices may be any of a variety of different types of devices that handle fluids. For example, the fluid-handling devices may be a valve, a pump, a process chamber (for instance a oil/water separation tank), or a process filter, or level switch. In some cases, the fluid-handling device may include an actuator, for instance an electric motor or a hydraulic drive, by which fluid flow or other parameters are manipulated, a sensor 56 by which process parameters are measured, or a local controller 58 by which power to the actuator 54 is modulated. Fluid-handling devices 38 may include a variety of types of sensors, for instance, a temperature, viscosity, flowrate, fluid level, pressure, conductivity, or other parameter sensor.

The illustrated fluid-handling device 40 is shown with feedback control of the actuator 54 by the local controller 58 based on measurements from the sensor 56 or measurements from sensors that are associated with other site master-controllers (e.g., site master-controllers 20 or 22), but other embodiments may include an actuator with feed-forward control, including actuators controlled by an on-off switch without sensor feedback. The local controller 58 may be operative to receive a command to drive the actuator 54 from a current setpoint to a target setpoint and control the flow of power (e.g. hydraulic or electric power) to the actuator 54 to implement the requested change of state. For instance, the controller 58 may receive a command to change a speed, pressure, or flowrate of a pump and may respond by increasing or decreasing a flow of electric or hydraulic power to an electrical or hydraulic motor driving such a pump. Or the controller 58 may receive a command to open or close a valve and, in response, may increase or decrease a flow of electric or hydraulic power to a corresponding actuator that opens or closes the valve.

In some cases, the local controllers 58 may have relatively limited processing power, such that more complicated changes in state are executed responsive to multiple commands to the respective fluid-handling device 38. For example, a fluid-handling device 38 with feed-forward control may receive a command to adjust to a target setpoint, return sensor data to the site master-controller 18, and receive a subsequent command to adjust further based on a determination made by the site master-controller 18 based on the sensor data. In another example, a stuck-valve may be loosened by a series of commands issued from the site master-controller 18 causing a local controller 58 to oscillate between states, working the stuck-valve loose. Similarly, shocks to upstream or down-stream fluid-handling devices may be mitigated by a series of commands gradually changing the state of a given fluid-handling device, for instance gradually ramping up or down the speed of a pump or gradually opening or closing a valve. In some embodiments, an action that affects the system, yet originates from outside the system, may use logic from a controller in the local system, such as a relatively drastic or rapid reduction in a specific tank level, which may indicate that a leak in a tank may exists, and the outside logic may provide which tank is experiencing the leak.

The site master-controller 18, in some embodiments, communicates with the fluid-handling devices 38 via a plurality of control buses 60 (individually labeled as 62, 64, and 66). Each control bus 60 may be operative to convey commands to one or more of the fluid-handling devices 38 using a different protocol. In this example, control bus 66 communicates with fluid-handling devices 42 and 40, control bus 64 communicates with fluid-handling device 44, and control bus 62 communicates with fluid-handling devices 46 and 48, but this arrangement is merely an example, and other embodiments may include more or fewer control buses, more or fewer fluid-handling devices per control bus, and more or fewer control buses per fluid-handling device. The control buses 60 may be serial or parallel control buses conveying digital or analog signals.

In one particular implementation, intended to serve merely as an example, the control bus 66 conveys commands and data using a serial communication protocol, such as the Modbus remote terminal unit (RTU) protocol, in which commands and other data are encoded in binary signals packaged in frames having redundant bits for detecting errors. The fluid-handling devices 40 and 42 on the bus 66, in this example, each have a unique address on the bus 66 by which commands from the site master-controller 68 are addressed to specific fluid-handling devices 40 or 42, and these addresses may be stored in memory of the site master-controller 18 as described in greater detail below. In some examples, site master-controller 18 acts as a master device on the bus 66, controlling which devices are permitted to transmit signals on the bus 66 at a given point in time. In this example, the fluid-handling devices 42 and 40 may include a bus interface that detects when a command is addressed to the respective fluid-handling device and stores the command for further processing, for example by a local controller 58 that implements the command. For example, fluid-handling device 40 may be a pump, and the bus 66 may convey commands to the local controller 58 to increase the speed of the actuator 54, for example an electric motor speed, to increase a pumping flowrate or pressure. In another example, the site master-controller 18 may issue a command on bus 66 to fluid-handling device 40 to return a value sensed by sensor 56, for example a measured pump speed, pressure, or flowrate.

In another aspect of this particular implementation, the bus 64 conveys a single value, for example a binary on/off value encoded in a voltage or current, or an analog control signal, encoded in a current or voltage, to one fluid-handling device 44 via a single wire (or pair of wires, if a reference different from ground is used). In some cases, the value may be a voltage ranging from 0 to 5 V, or some other range, in which a relatively low voltage, below a threshold, corresponds to an off signal, and a relatively high voltage, above a threshold, corresponds to an on signal. In some cases, the same command may be conveyed to multiple fluid-handling devices connected in series or parallel, or multiple commands may be conveyed by multiple wires in parallel to a single fluid-handling device or multiple fluid-handling devices, for instance one on-off signal per fluid-handling device. In one or more instances the bus 64 may connect to a data acquisition board of the site master-controller 18 for manipulating voltage or current to encode commands. In one example, the bus 64 conveys a binary value to a local controller for a valve actuator as a voltage-high or voltage-low signal, commanding the valve to open or close, respectively. In some cases, instances of the bus 64 may also return data to the site master-controller 18, for example as an analog signal indicating the state of a sensor. In some embodiments, instances of the bus 64 may connect to sensors on fluid-handling devices that are also connected to the bus 66 or the bus 62, e.g., returning sensor values, while the other buses convey commands.

In another aspect of this particular example implementation, the bus 62 is an Ethernet bus, forming a private local area network by which the site master-controller 18 communicates with fluid-handling devices 46 and 48 via the Ethernet protocol. Examples of various forms of constraints and set point targeting that might be implemented with such communications are described below with reference to local controllers. In this example, data is conveyed in frames of binary data, and each of the site master-controller 18 and the fluid-handling devices 46 and 48 are associated with a respective network address that, when included in such a frame, indicates that the frame is addressed to the associated device. Frames may include redundancy to detect corrupted frames, and access to the bus 62 may be controlled in a distributed fashion, by each device sensing whether a transmission by the device caused a collision on the bus 62, e.g., using carrier-sense multiple-access techniques with collision detection. In this example, fluid-handling devices 46 and 48 may include network interfaces, such as network interface cards or integrated devices that detect frames addressed to the corresponding fluid-handling device 46 or 48, capture the frames, and store commands encoded in the frames (e.g., in a buffer) for subsequent processing by a local controller. Similarly, the fluid-handling devices 46 and 48 may return data to the site master-controller 18, for example data from sensors of the fluid-handling devices, using the Ethernet protocol.

As noted above, the site master-controller 18, in this embodiment, like the other site master-controller 20 and 22, is operative to receive commands from the command-center server 14 and translate those commands in accordance with both protocols of the respective buses 62, 64, or 66 and command formats supported by the fluid-handling devices 38 (e.g., command codes, on-off signals, application-program interfaces, and the like, depending on the device). To this end, in this embodiment, the site master-controller 18 includes a network interface 68, a site management module 70, a protocol multiplexer 72, command translators 74 (individually labeled as 76, 78, 80), controllers 82 (individually labeled as 84, 86, 88, 90, 92, and 94), and input/output modules 96 (individually labeled as 98, 100, and 102). The site master-controller 18 may also include a report buffer 104 that stores data to be reported back to the command-center server 14 or to be published via the messaging server 11.

The illustrated network interface 68 is operative to communicate with the command-center server 14 via the Internet 30 (e.g., via the Internet and other networks, such as a local area network, a cellular network, or the like). In some embodiments, the site management module 70 communicates with the network interface 68 via application program interfaces of an operating system in which the site master-controller 18 is executed.

The illustrated site-management module 70 is operative to coordinate the operation of the other components of the site master-controller 18. In some cases, the site management module 70 monitors a network socket defined by an Internet protocol address and port of the site master-controller 18 and handles events, e.g., incoming commands, from the network socket. In some embodiments, the site-management module 70 is implemented with multiple threads, in a system in which one thread sends and receives data request; one thread controls and monitors the current state of the system, causing other threads to be synced with current information; one thread writes to writeable devices (e.g., devices having memory) to set the target state of each device; one thread that handles server interaction for updating and receiving; one thread that handles user interaction (e.g., presenting interfaces on an local display, receiving user input, and handling events from such input); one thread that handles subscriptions of a publish/subscribe architecture, one thread that handles publications of a publish/subscribe architecture, and one thread that eliminates threads that become problematic.

The site manager module 70 may also be operative to transmit data with the network socket, using the network interface 68, to the command-center server 14 or the messaging server 11 via a publication. For example, the site manager module 70 may periodically retrieve data from the report buffer 104, such as alarms, measurements from sensors, and other data associated with the fluid-handling site 24, and push this data to the command-center server 14. Or the site management module 70 may be operative to receive requests for such data being pulled from the command-center server 14, and retrieve the corresponding data from the report buffer 104 for transmission back to the command-center server 14. Further, the site manager module 70 may be operative to request measurements, alarms, and other data from the fluid-handling devices via the components 72, 74, 82, and 96, and store this data in the report buffer 104 for transmission to the command-center server 14 or publish the data at the messaging server 11.

In this embodiment, when the site management module 70 receives a command via the network interface 68, or issues its own command (e.g., to poll sensors or alarm logs), the command is conveyed to a protocol multiplexer 72, which may be operative to determine which control bus 60 and fluid-handling device 38 will receive a corresponding translated command. For example, the protocol multiplexer 72 may store in memory records for communicating with the fluid-handling devices 38. Each record may correspond to a individual fluid-handling device 38 or an individual actuator or sensor of a fluid-handling device, and each record may include a unique identifier of the corresponding device, actuator, or sensor; a control bus address of the device, actuator, or sensor (for those components on a control bus that is addressable); an identifier of the control bus 62, 64, or 66 through which the site master-controller 18 communicates with the device, actuator, or sensor; and an identifier of the protocol through which such communication occurs.

When a command is received at the protocol multiplexer 72, in some embodiments, the command includes the identifier of the device, actuator, or sensor to which the command is directed, and using this identifier, the protocol multiplexer 72 retrieves the corresponding record from memory to identify the appropriate protocol. In this example, based on the protocol in the record, the protocol multiplexer 72 selects among the command translators 74, each of which corresponds to a different protocol. For example, the command translator 80 may correspond to a protocol of control bus 66, such as the modbus RTU protocol; the command translator 78 may corresponds to a protocol of the control bus 64, such as a binary or analog voltage or current signal conveyed via a data acquisition board; and the command translator 76 may corresponds to a protocol of the control bus 62, such as the Ethernet protocol.

The command translators 74 may be operative to translate a received command from an input format to a format configured to effectuate changes in the fluid-handling devices 38. For instance, a generic command to open a valve may be sent from the control-center server 14, and that command may be translated to differently depending on the specific protocol used to communicate with the corresponding valve at a given site, with different sites potentially employing different protocols for the task. Translating commands may abstract the details of the site-specific implementations away from those implementing the command-center server 14, facilitating relatively rapid deployment of new features or sites.

In one example of translation, the command translator 80 may receive a command to increase a pump speed, and the command translator may determine a corresponding command via calculation or look-up table, such as a modbus function code and associated data, that when conveyed via the control bus 66 causes a corresponding fluid-handling device 40 or 42 to change state. In some embodiments, prior to execution, the command is checked for validity, to ensure the current conditions of the system warrant that the commanded action occur to preventing harm to the fluid-handling devices.

For example, some embodiments may store in memory accessible to the command translator 80 system constraints describing acceptable patterns of input and output parameters. The system constraints may be selected to prevent damage to the system, e.g., a maximum speed for a pump, a maximum or minimum liquid height for a tank, a maximum or minimum fluid pressure, a maximum or minimum flow rate, an impermissible pattern of open valves that would leak oil outside of the system, etc. A command may be compared against these constraints to determine whether the command would cause the system to violate one of the constraints. In response to determining that the command would violate a constraint, the command may be rejected, an override confirmation may be requested from the operator, or the command may be executed to the extent permitted by the constraints, for instance.

Some embodiments may execute the translated commands in different modes. For instance, in an automatic mode, the command translator 80 may select set points to keep the system within the above-described constraints, execute a process recipe in which a collection of set points are targeted, or to target other output set points given the above described constraints. In another example, the system may operate in a mixed automatic mode in which the user selects which devices are manually controlled while other devices are automatically controlled. In a third example, a manual mode, each of the devices may be controlled manually.

In another example, the command translator 78 may be operative to determine whether a command corresponds to a particular voltage or current on an individual instance of the control bus 64. For example, a command to dislodge a stuck valve may be translated by the command translator 78 into a sequence of on and off signals conveyed via a high and low voltage on an individual wire corresponding to bus 64.

In another example, the command translator 76 may be operative to translate commands into a format configured to change the state of fluid-handling devices 46 or 48. Or in some embodiments, command translator 76 is operative to pass through and un-translated command if appropriately formatted as received from the command-center server 14.

Some embodiments may include controllers 82 operative to execute control routines implicated by the translated commands on an individual device 38, actuator 54, or sensor 56. To this end, the commands translator 74, in addition to transmitting commands, may also route the translated command to a controller 82 corresponding to the specific device, actuator, or sensor to which the command is directed. The controllers 82 may determine set points corresponding to (or conveyed in) the command, send control signals configured to drive the fluid-handling device to the set points, and receive feedback from the fluid-handling device 38 indicative of whether the fluid-handling device 38 has achieved the target set point. In some embodiments, the controllers 82 include proportional-integral-derivative controllers for exercising feedback control, or the controllers 82 may include feed forward control algorithms (e.g., look-up tables or formulas for calculating commands based on set points). Further, in some embodiments, the controllers 82 may change the set point over time in accordance with the received command, for example a command to gradually ramp up a motor speed, a command to gradually open a valve, or a command to oscillate the position of a valve to dislodge a stuck valve. Algorithms for changing the set point may be stored in memory accessible to the controllers 82 responsive to a translated command implicating the specific algorithm.

The illustrated input/output modules 26 include, in some embodiments, link-layer devices that accommodate the particular features of the physical medium with which control buses 62, 64, and 66 are implemented. In some cases, the input/output modules 96 also perform encoding and decoding at the network and transport layer, for example packaging data in appropriately structured frames for the respective control bus 60. In one example, the input/output module 102 includes a modbus modem, the input/output module 100 includes a data acquisition board (for example a printed circuit board having one or more digital-to-analog converters or analog-to-digital converters), and the input/output module 98 includes an Ethernet network interface card.

The site master-controller 18, thus, may be operative to receive commands from the site server 36 of the command-center server 14, translate those commands, identify the appropriate control bus 60 and, if needed, address on the control bus, and implement the command once received, even if network access is lost after the command is issued from the command-center server 14. Further, the site master-controller 18, in some embodiments, is operative to retrieve sensor data, alarms, and other site data, and buffer such data in the report buffer 104, before the data is periodically returned to the command-center server 14, such that buffered data is not lost if network access ceases intermittently. Accordingly, some embodiments provide control and monitoring of remote fluid handling sites 24 that is relatively robust to interruptions in network service, and some embodiments facilitate such monitoring and control via a web browser on user devices 26 and 28, such that the addition of new devices or users is relatively simple compared to systems that require special purpose applications. Again though, not all embodiments provide these benefits, and some embodiments may provide other benefits.

The components of the site master-controller 18 and command-center server 14 are described above with reference to discrete functional blocks and as discrete unitary components, but it should be understood that software or hardware by which these functional blocks or components are implemented may be distributed across multiple computing systems or multiple processes within a computing system, and code, stored in a tangible, non-transitory, machine-readable medium, for providing this functionality or the functionality described below may be intermingled, conjoined, divided, or otherwise differently organized than the manner in which the functional blocks are illustrated.

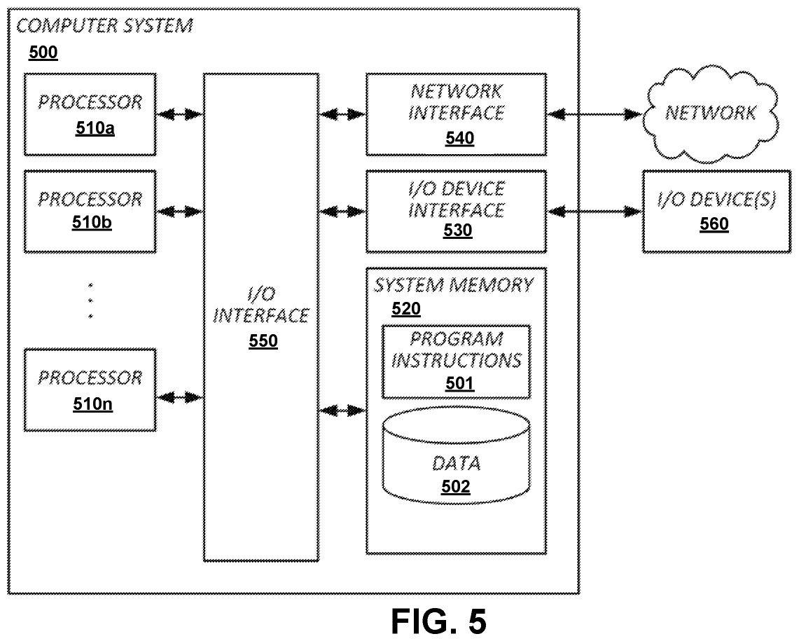

Referring now to FIG. 2, an embodiment of a messaging server 200 is illustrated that may be the messaging server 11 discussed above with reference to FIG. 1. As such, the messaging server 200 may be a computer system 500 discussed below with reference to FIG. 5 or may include some or all of the components of the computing system 500, and in specific embodiments may be provided by a server or other computing devices that would be apparent to one of skill in the art in possession of the present disclosure. In the illustrated embodiment, the messaging server 200 includes a chassis 202 that houses the components of the messaging server 200, only some of which are illustrated in FIG. 2. For example, the chassis 202 may house a processing system (not illustrated, but which may include the processor discussed below with reference to FIG. 5) and a memory system (not illustrated, but which may include the system memory discussed above with reference to FIG. 5) that is coupled to the processing system and that includes instructions that, when executed by the processing system, cause the processing system to provide a messaging service engine 204 that is configured to perform the functionality of the messaging service engines and messaging servers discussed below. In the examples discussed below, the messaging service engine 204 provides message-oriented middleware that includes a publish-subscribe manager 206, although the provision of other message-oriented patterns by the messaging service engine 204 are envisioned as falling within the scope of the present disclosure. In some embodiments, the messaging service engine 204 or the publish-subscribe manager 206 may include Redis or other message-oriented applications that would be apparent to one of skill in the art in possession of the present disclosure.

The chassis 202 may also house a storage system (not illustrated, but which may include the storage device discussed below with reference to FIG. 5) that is coupled to the messaging service engine 204 (e.g., via a coupling between the storage system and the processing system) and that includes a messaging database 208 that is configured to provide for the storage of information from message queues 210 managed by the publish-subscribe managers 206, as well as store any of the data that enables the functionality discussed below. The chassis 202 may also house a communication system 212 that is coupled to the messaging service engine 204 (e.g., via a coupling between the communication system 212 and the processing system) and that may include a Network Interface Controller (NIC), a wireless communication subsystem (e.g., a BLUETOOTH® communication subsystem, an NFC communication subsystem, etc.), or other communication components that enable the communication discussed below. While a specific embodiment of a messaging server 200 has been described, one of skill in the art in possession of the present disclosure will recognize that other messaging servers may be provided with a variety of other components that provide for conventional message-oriented middleware functionality, as well as the functionality discussed below, while remaining within the scope of the present disclosure.

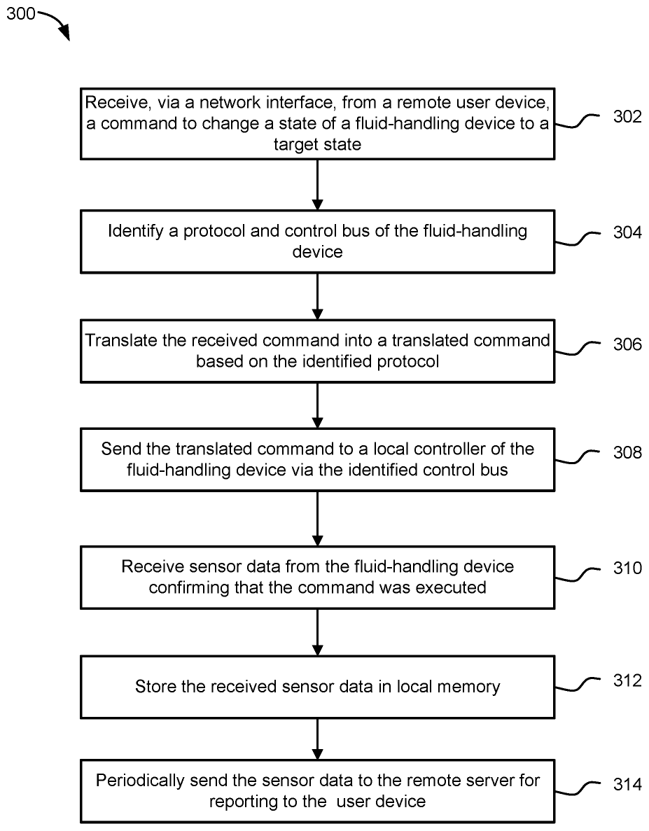

FIG. 3 illustrates an embodiment of a process 300 for exercising remote control of a fluid-handling site. The process 300 may be performed by the above-described site master-controllers 16, though embodiments are not limited to the implementations described above. Further, embodiments may include additional steps, fewer steps, and steps in a different order from the manner in which the process 300 is illustrated, which is not to suggest that any other feature described herein is required in all embodiments or cannot be modified.

In some embodiments, the process 300 includes receiving, via a network interface, from a remote user device, (e.g., via a command-center server) a command to change a state of a fluid-handling device to a target state, as illustrated by block 302. The command may be received from, for example, the above-described site server 36, which may have received the command from a remote user device via a web browser of the user device. Further, the command to change the fluid-handling device to a target state may include a command that changes the fluid-handling device to a plurality of different states over time, such as a command to ramp up or down a motor speed or oscillate some parameter.

In some embodiments, the process 300 includes identifying a protocol and control bus of the fluid-handling device, as illustrated by block 304. Identifying a protocol and control bus may include parsing an identifier of a device, actuator, or sensor from the received command and retrieving a corresponding record based on the identifier, the record including an identifier of the protocol and control bus. In some embodiments, the retrieved record may also include an identifier of a control bus address of the corresponding device, actuator, or sensor.

In some embodiments, the process 300 includes translating the received command into a translated command based on the identified protocol, as illustrated by block 306. Examples of such translation are described above with reference to the command translators 74.

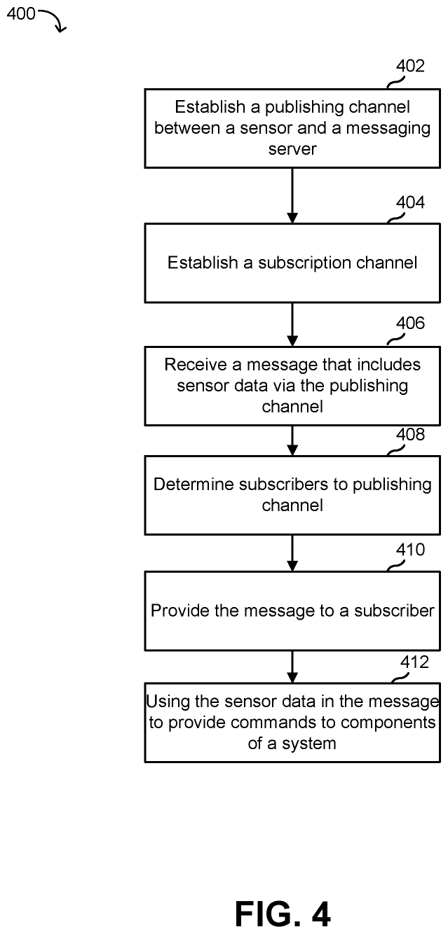

The process 300 may also include sending the translated command to a local controller of the fluid-handling device via the identified control bus, as illustrated by block 308. Sending the translated command may include exercising feedback control of the fluid-handling device based on sensor data received from the fluid-handling device by adjusting a set point sent to the local controller. Or in some use cases, sending the translated command may include sending a sequence of set points that change over time. In some embodiments, the sensor data may be received according to the publish/subscribe architecture and process 400 discussed below in FIG. 4.

In some embodiments, the process 300 includes receiving sensor data from the fluid-handling device confirming that the command was executed, as illustrated by block 310. As with the other features described herein, not all embodiments include this step. Using this data, some embodiments may exercise feedback control or may retrieve sensor measurements following the execution of a command for reporting to the user device. In some cases, the sensor data is retrieved regardless of whether a command was issued, for example periodically to monitor the state of the fluid-handling device. As discussed in further detail below in FIG. 4, the sensor data may be received in a message that was published by a sensor, a fluid-handling device, a site master-controller, or command-center server at the messaging server 11 and the published message or topic at which the message is published may be subscribed to by the site master-controller that is to retrieve and use the sensor data included in the message. In one example, the fluid-handling device is an oil/water separation tank, and a set point of a pump is adjusted to change a fluid level in the tank, e.g., a level at which oil meets water or a level of the oil.

In some embodiments, the received sensor data is stored in local memory, as illustrated by block 312. For example, the received sensor data may be stored in the above-described report buffer 104.

In some embodiments, the process 300 further includes periodically sending the sensor data to the remote server for reporting to the user device, as illustrated by block 314. Periodically, data from the report buffer may be transmitted to the above-described command-center server 14 for compilation of reports requested by user devices 26 to 28. Similarly, alarms or other log data issued by fluid-handling devices may also be retrieved, stored, and transmitted to the command-center server 14 for reporting. As discussed below, the sensor data may be provided in a message and published to a topic at the messaging server 11. The command-center server 14 may be a subscriber to the topic and the messaging server 11 may provide the message that includes the sensor data to the command-center server 14.

Thus, systems implementing the process 300, in some embodiments, offer relatively robust control and monitoring of fluid-handling devices that are geographically distributed. This is expected to lower the costs associated with operating such fluid-handling devices and facilitate the extraction of petroleum products and other processing of fluids. Such control and monitoring are often enhanced when coupled with sensor data that is received quickly with low latency and resilience, for instance, as provided by the messaging server 11.

FIG. 4 illustrates an embodiment of a process 400 for a low-latency, resilient publish/subscribe architecture for remote sensor data retrieval for control of a fluid-handling site or fluid-handling system with a plurality of fluid-handling sites. The process 400 may be performed by the above-described site master-controllers 16, the messaging server 11, fluid-handling devices 38, or sensors 56 though embodiments are not limited to the implementations described above. Further, embodiments may include additional steps, fewer steps, and steps in a different order from the manner in which the process 400 is illustrated, which is not to suggest that any other feature described herein is required in all embodiments or cannot be modified.

In some embodiments, the process 400 may begin at block 402 where a publishing channel is established between a sensor and a messaging server. In various embodiment of the present disclosure the messaging server 11/200 may implement a publish/subscribe messaging paradigm where senders (publishers) are not programmed to send their messages to specific receivers (subscribers). Rather, published messages are characterized into channels, without knowledge of what (if any) subscribers there may be. Subscribers express interest in one or more channels, and only receive messages that are of interest, without knowledge of what (if any) publishers there are. This decoupling of publishers and subscribers can allow for greater scalability and a more dynamic network topology. In an embodiment, at block 402, the publish-subscribe manager 206 may establish a publishing channel between a site master-controller 16 that is in communication with a sensor, a sensor 56 directly, the command center server 14, or a third-party server, oracle, or database, or any other device that can provide sensor data that would be apparent to one of skill in the art in possession of the present disclosure. In some embodiments, the publish-subscribe manager 206 may be provided by Redis or other publish/subscribe middleware that would be apparent to one of skill in the art. In various embodiments, each publishing channel may be associated with a publish identifier. While embodiments of the present disclosure are discussed using the Redis architecture, other publish-subscribe architectures or message-oriented middleware that would be apparent to one of skill in the art in possession of the present disclosure may be contemplated without departing from the scope of the present disclosure.

The process 400 may proceed to block 404 where subscription channels are established. In an embodiment, at block 404, subscribers such as site-master controllers 16 may subscribe to one or more publishing channels. For example, the subscriber may provide the publish identifier for the publication channel for which it is going to subscribe. For instance, in order to subscribe to one or more publishing channels the client (subscriber) issues a subscribe command providing the publish identifier(s) of the publishing channel(s) via a command line interface. As such, the subscriber may register for messages at build time, initialization time, or runtime.

Messages sent or published by other clients to these channels will be pushed by the publish-subscribe manager 206 to all the subscribed clients. A client subscribed to one or more channels should not issue commands, although it can subscribe and unsubscribe to and from other channels. The replies to subscription and unsubscribing operations are sent in the form of messages, so that the client can just read a coherent stream of messages where the first element indicates the type of message. The commands that may be allowed in the context of a subscribed client may include SUBSCRIBE, SSUBSCRIBE, SUNSUBSCRIBE, PSUBSCRIBE, UNSUBSCRIBE, PUNSUBSCRIBE, PING, RESET, QUIT or other commands that would be apparent to one of skill in the art in possession of the present disclosure.

In various embodiments, a message may be an array-reply (e.g., a Redis serialization protocol (RESP) array) with three elements. For example, the first element may include a message type (e.g., subscribe, unsubscribe, or message). In a subscribe message the second element may include the channel that was successfully subscribed and the third element represents a number of channels the subscriber is currently subscribed to. In an unsubscribe message the second element is the channel that the client was successfully unsubscribed from and the third element represents the number of channels the client is currently subscribed to. When the last element is zero, the client is no longer subscribed to any channel, and the client may issue any kind of messaging service command (e.g., a Redis command) as the client is outside the publish/subscribe state. When the message type is “message,” the message received may be a result of a PUBLISH command issued by another client. The second element may be the name of the originating publishing channel, and the third element may be the actual message payload (e.g., sensor data).

In various embodiments, the publish-subscribe manager 206 may support pattern matching. Clients may subscribe to glob-style patterns in order to receive all the messages sent to channel names matching a given pattern. For instance: PSUBSCRIBE channel name.* will receive all the messages sent to the channel channel name.subchannel(1).subchannel(2), channel name.subchannel(3).subchannel(4), and the like. All the glob-style patterns may be valid, so multiple wildcards may be supported. A similar unsubscribe command may be used to unsubscribe the client from that pattern and no other subscriptions will be affected by the call. Messages received as a result of the pattern matching may be sent in a different format with four elements. The type of the message may be a “pmessage” that is a message received as result of a PUBLISH command issued by another client, matching a pattern-matching subscription. The second element may include the original pattern matched. The third element may include the name of the originating channel. Finally, the last element may include the actual message payload.

If a message matches both a pattern and a channel subscription, the subscriber client may receive a single message multiple times. For example, if the client is subscribed to multiple patterns matching a published message, or if it is subscribed to both patterns and channels matching the message, then it may receive multiple messages.

In various embodiments, the publish-subscribe manager 206 may include a sharded publish/subscribe architecture in which shard channels are assigned to slots by the same algorithm used to assign keys to slots. A shard message may be sent to a node that owns the slot the shard channel is hashed to. The cluster makes sure the published shard messages are forwarded to all nodes in the shard, so clients can subscribe to a shard channel by connecting to either the master responsible for the slot, or to any of its replicas. A sharded publish/subscribe algorithm helps to scale the usage of publish/subscribe in cluster mode. It restricts the propagation of message to be within the shard of a cluster. Hence, the amount of data passing through the cluster bus is limited in comparison to global Pub/Sub where each message propagates to each node in the cluster. This allows users to horizontally scale the publish/subscribe usage by adding more shards. While the example discusses a topic-based publish/subscribe model where the publish-subscribe manager filters messages based on topic or publishing channels other publish/subscribe models may be implemented that are content-based such that messages are only provided to a subscriber if the attributes or content of those message matches constraints defined by the subscriber (e.g., the subscriber is responsible for classifying the messages). Hybrids of topic-based and content-based systems are also contemplated where publishers post message to a topic while subscribers register content-based subscription to one or more topics.

Furthermore, the publish-subscribe manager 206 may not be provided as a message broker but may include a data distribution service that may include middleware that does not use a broker in the middle. Instead, each publisher and subscriber in the system shares meta-data about each other via IP multicast. The publishers and the subscribers may cache this information locally and route messages based on the discovery of each other in the shared knowledge of each other. As such, the publish-subscribe manager 206 may construct an overlay network which allows efficient decentralized routing from publishers to subscribers.

The process 400 may proceed to block 406 where a message that includes sensor data is received. In an embodiment, at block 406, the publish-subscribe manager 206 may receive a message that includes first sensor data obtained by a sensor. The message may be associated with a publishing identifier and the publish-subscribe manager 206 may associate the message with the publishing channel based on the publishing identifier. For example, the command from a client via the publish/subscribe command line interface may include PUBLISH “channel name” “payload” where the channel name is the publishing identifier and the payload is the sensor data. The publish-subscribe manager 206 may parse the message and determine the publishing channel from the publishing identifier included in the message. As such, the publish-subscribe manager 206 may function as a message broker and performs a store and forward function to route messages from publishers and subscribers. The publish-subscribe manager 206 may also prioritize messages in the message queue 210 before routing the message to the subscriber.

The process 400 may proceed to block 408 where subscribers to the publishing channel are determined. In an embodiment, at block 408, the publish-subscribe manager 206 may determine subscribers for the publishing channel that includes the message. The publish-subscribe manager 206 may determine subscribers that provided the publish identifier for the publishing channel.

The process 400 may proceed to block 410 where the message that includes the sensor data is provided to the computer system that is a subscriber to the publishing channel. In an embodiment, at block 410, the publish-subscribe manager 206 may provide the message that includes the sensor data to the subscribers of that publishing channel while subscribers to other publishing channels are not provided the message. As such, published messages are characterized into channels, without knowledge of what (if any) subscribers there may be. Subscribers express interest in one or more channels, and only receive messages that are of interest, without knowledge of what (if any) publishers there are. This decoupling of publishers and subscribers can allow for greater scalability and a more dynamic network topology. Furthermore, the three-element messaging scheme provides for resilience and low latency required for informing fluid-control systems of sensor data by simplifying the communications provided over the network.

The process 400 may proceed to block 412 where the sensor data is used by the computer system to provide commands to components of a system. In an embodiment, at block 412, the site master controller 16 may exercise feedback control or may retrieve sensor measurements following the execution of a command for reporting to the user device. In some cases, the sensor data is retrieved regardless of whether a command was issued, for example periodically to monitor the state of the fluid-handling device. In one example, the fluid-handling device is an oil/water separation tank, and a set point of a pump is adjusted to change a fluid level in the tank, e.g., a level at which oil meets water or a level of the oil. As such, the sensor data may be used by the site master controller 16 to control the fluid-handling devices 38.

By implementing the publish/subscribe architecture, systems and methods of the present disclosure may assist in a system with a plurality of sensors and a plurality of site-master controllers 16. For example, a pipeline may have a plurality of site-master controllers 16 at various locations along the pipeline and sensors at that those locations or other locations along the pipeline. In some embodiments, the sensors may include 3^{rd} party data (e.g., weather data). The site-master controllers 16 may subscribe to one or more sensors along the pipeline. The sensors or site-master controllers 16 associated with the sensors may publish to one or more publishing channels. The sensors may publish a message at the publish-subscribe manager 206 and as the pipeline operates and sensors generate sensor data, information at one location may be used to by a site-master controller at another location to control a fluid handling device. As such, control commands may be dependent on downstream information (e.g., downstream flow or flow along the pipeline to control upstream flow.

In another example, site-master controllers regulating a fluid-handling device that is independent of fluid-handling devices controlled by another site-master controller may also benefit from the disclosure of the present disclosure. For example, a farm that includes a fluid-handling device to control irrigation of crops may subscribe to a publishing channel that includes precipitation readings from sensors at farms in the vicinity of the farm. If messages are received from the channel and those messages include sensor data that rain or the amount of rain is heading toward the farm meets certain requirements, the site-master controller may execute commands that regulate the fluid-handling device(s) of the irrigation system, which may conserver water in greater quantities than if the site-master controller receives the precipitation readings locally from its own sensors.

In further embodiments, publish/subscribe systems may pose security issues. For example, a subscriber might be able to receive data that it is not authorized to receive, or an unauthorized publisher may be able to introduce incorrect or damaging messages into the publish subscribe system. Even authorized publishers may introduce damaging messages into the system. Embodiments, of the present disclosure may render the message tamper evident via a blockchain. The publish-subscribe manager 206 may store the publish and message sending transactions to a blockchain such that tampering with the publish-subscribe system can be monitored. Furthermore, in some embodiments, the messages may be homomorphically encrypted such that the subscriber can use the data in its encrypted form

FIG. 5 is a diagram that illustrates a computing system 500 example, in accordance with embodiments of the present technique. Various portions of systems and methods described herein, may include or be executed on one or more computer systems similar to computing system 500. Further, processes and modules described herein may be executed by one or more processing systems similar to that of computing system 500.

Computing system 500 may include one or more processors (e.g., processors 510a-510n) coupled to system memory 520, an input/output I/O device interface 530, and a network interface 540 via an input/output (I/O) interface 550. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 500. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 520). Computing system 500 may be a uni-processor system including one processor (e.g., processor 510a), or a multi-processor system including any number of suitable processors (e.g., 510a-510n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 500 may include a plurality of computing devices (e.g., distributed computer systems) to implement various processing functions.

I/O device interface 530 may provide an interface for connection of one or more I/O devices 560 to computer system 500. I/O devices may include devices that receive input (e.g., from a user) or output information (e.g., to a user). I/O devices 560 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 560 may be connected to computer system 500 through a wired or wireless connection. I/O devices 560 may be connected to computer system 500 from a remote location. I/O devices 560 located on remote computer system, for example, may be connected to computer system 500 via a network and network interface 540.

Network interface 540 may include a network adapter that provides for connection of computer system 500 to a network. Network interface may 540 may facilitate data exchange between computer system 500 and other devices connected to the network. Network interface 540 may support wired or wireless communication. The network may include an electronic communication network, such as the Internet, a local area network (LAN), a wide area network (WAN), a cellular communications network, or the like.

System memory 520 may be configured to store program instructions 501 or data 502. Program instructions 501 may be executable by a processor (e.g., one or more of processors 510a-510n) to implement one or more embodiments of the present techniques. Instructions 501 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 520 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM or DVD-ROM, hard-drives), or the like. System memory 520 may include a non-transitory computer readable storage medium that may have program instructions stored thereon that are executable by a computer processor (e.g., one or more of processors 510a-510n) to cause the subject matter and the functional operations described herein. A memory (e.g., system memory 520) may include a single memory device or a plurality of memory devices (e.g., distributed memory devices).

I/O interface 550 may be configured to coordinate I/O traffic between processors 510a-510n, system memory 520, network interface 540, I/O devices 560, or other peripheral devices. I/O interface 550 may perform protocol, timing, or other data transformations to convert data signals from one component (e.g., system memory 520) into a format suitable for use by another component (e.g., processors 510a-510n). I/O interface 550 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 500 or multiple computer systems 500 configured to host different portions or instances of embodiments. Multiple computer systems 500 may provide for parallel or sequential processing/execution of one or more portions of the techniques described herein.

Those skilled in the art will appreciate that computer system 500 is merely illustrative and is not intended to limit the scope of the techniques described herein. Computer system 500 may include any combination of devices or software that may perform or otherwise provide for the performance of the techniques described herein. For example, computer system 500 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 500 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

What is claimed is:

1. A system, comprising:
a first computer system disposed at a first fluid handling site, the first computer system being configured to provide control of at least one fluid handling component;
a first sensor located at the first fluid handling site or a second fluid handling site, wherein the first sensor is configured to obtain first sensor data; and
a messaging server that includes one or more processors; and memory storing instructions that when executed by the one or more processors cause the one or more processors to effectuate operations of:
receiving a first message that includes the first sensor data obtained by the first sensor, wherein the first message is associated with a first publishing identifier; and
providing the first message that includes the first sensor data to the first computer system in response to determining that the first computer system is subscribed to the first publishing identifier.

2. The system of claim 1, wherein the first sensor data causes the first computer system to provide a first control command to the at least one fluid handling component based on the first sensor data.

3. The system of claim 1, further comprising a second sensor located at the first fluid handling site, the second fluid handling site, or a third fluid handling site, wherein the second sensor is configured to obtain second sensor data, wherein the messaging server is further configured to:
receive a second message that includes the second sensor data obtained by the second sensor, wherein the second message is associated with a second publishing identifier; and
prevent the second message from being provided to the first computer system in response to determining that the first computer system is not subscribed to the second publishing identifier.

4. The system of claim 1, further comprising a second computer system disposed at the first fluid handling site, the second fluid handling site or a third fluid handling site, the second computer system being configured to provide control of at least one second fluid handling component, wherein the messaging server is further configured to:
prevent the first message from being provided to the second computer system in response to determining that the second computer system is not subscribed to the first publishing identifier.

5. The system of claim 1, further comprising a second computer system disposed at the first fluid handling site, the second fluid handling site or a third fluid handling site, the second computer system being configured to provide control of at least one second fluid handling component, wherein the messaging server is further configured to:
provide the first message that includes the first sensor data to the second computer system in response to determining that the second computer system is subscribed to the first publishing identifier.

6. The system of claim 5, wherein the first sensor data causes the second computer system to provide a second control command to the at least one second fluid handling component based on the first sensor data.

7. The system of claim 1, wherein the messaging server is configured to:
receive a second message that includes updated first sensor data obtained by the first sensor at a subsequent time, wherein the second message is associated with the first publishing identifier; and
provide the second message that includes the updated first sensor data to the first computer system in response to determining that the first computer system is subscribed to the first publishing identifier.

8. The system of claim 1, wherein the messaging server is configured to establish a publishing channel with the first sensor.

9. A method, comprising:
receiving, by a messaging server, a first message that includes first sensor data obtained by a first sensor, wherein the first message is associated with a first publishing identifier, wherein the first sensor is configured to obtain the first sensor data;
determining, by the messaging server, one or more computer systems that are subscribed to the first publishing identifier; and
providing, by the messaging server, the first message that includes the first sensor data to a first computer system of the one or more computer systems, wherein the first computer system is disposed at a first fluid handling site, the first computer system being configured to provide control of at least one fluid handling component.

10. The method of claim 9, wherein the first sensor data causes the first computer system to provide a first control command to the at least one fluid handling component based on the first sensor data.

11. The method of claim 9, further comprising:
receiving, by the messaging server, a second message that includes second sensor data obtained by a second sensor, wherein the second message is associated with a second publishing identifier; and
preventing, by the messaging server, the second message from being provided to the first computer system in response to determining that the first computer system is not subscribed to the second publishing identifier.

12. The method of claim 11, further comprising:
determining, by the messaging server, one or more second computer systems that are subscribed to the second publishing identifier; and
providing, by the messaging server, the second message that includes the second sensor data to a second computer system of the one or more second computer systems, wherein the second computer system being configured to provide control of the at least one fluid handling component.

13. The method of claim 11, further comprising:
preventing, by the messaging server, the first message from being provided to a second computer system in response to determining that the second computer system is not subscribed to the first publishing identifier.

14. The method of claim 9, further comprising:
providing, by the messaging server, the first message that includes the first sensor data to a second computer system in response to determining that the second computer system is subscribed to the first publishing identifier.

15. The method of claim 14, wherein the first sensor data causes the second computer system to provide a second control command to at least one second fluid handling component based on the first sensor data.

16. The method of claim 9, further comprising:
receiving, by the messaging server, a second message that includes updated first sensor data obtained by the first sensor at a subsequent time, wherein the second message is associated with the first publishing identifier; and
providing, by the messaging server, the second message that includes the updated first sensor data to the first computer system in response to determining that the first computer system is subscribed to the first publishing identifier.

17. The method of claim 9, further comprising:
establishing, by the messaging server, a publishing channel with the first sensor.

18. A tangible, non-transitory, machine-readable medium storing instructions that when executed by one or more processors effectuate operations comprising:
receiving, by a messaging server, a first message that includes first sensor data obtained by a first sensor, wherein the first message is associated with a first publishing identifier, wherein the first sensor is configured to obtain the first sensor data;
determining, by the messaging server, one or more computer systems that are subscribed to the first publishing identifier; and
providing, by the messaging server, the first message that includes the first sensor data to a first computer system of the one or more computer systems, wherein the first computer system is disposed at a first fluid handling site, the first computer system being configured to provide control of at least one fluid handling component.

19. The medium of claim 18, wherein the first sensor data causes the first computer system to provide a first control command to the at least one fluid handling component based on the first sensor data.

20. The medium of claim 18, further comprising:
receiving, by the messaging server, a second message that includes second sensor data obtained by a second sensor, wherein the second message is associated with a second publishing identifier; and
preventing, by the messaging server, the second message from being provided to the first computer system in response to determining that the first computer system is not subscribed to the second publishing identifier.
